(19) United States
(12) Patent Application Publication
(10) Pub. No.: US 2026/0281836 A1
(43) Pub. Date: Sep. 17, 2026

(54) USER PLANE INTERRUPTION TIME MONITORING

(71) Applicant: Nokia Technologies Oy, Espoo (FI)

(72) Inventors: Martin KOLLÁR, Munich (DE); Irina-Mihaela BALAN, Munich (DE); Arled PAPA, Munich (DE); Krzysztof KORDYBACH, Wroclaw (PL)

(21) Appl. No.: 19/471,548

(22) PCT Filed: Mar. 21, 2024
(86) PCT No.: PCT/EP2024/057583

§ 371 Date: Oct. 1, 2025

(30) Foreign Application Priority Data
Apr. 6, 2023 (GB) 2305189.9

(51) Int. Cl. H04W 36/00

(52) U.S. Cl. CPC H04W 36/00695

(57) ABSTRACT

A method comprising: creating, for transmission, a radio resource control reconfiguration (RRCReconfiguration) message for a user equipment (UE), wherein the RRCReconfiguration message comprises a configuration for monitoring, at the UE, user plane interruption time relating to a primary secondary cell (PSCell) change during a dual connectivity session, wherein the configuration comprises an at least one indication of which one or more of a plurality of options one or more parameters for monitoring user plane interruption time associated with a dual connectivity split bearer are to be used, at the UE, for monitoring user plane interruption time associated with the a dual connectivity split bearer.

### TECHNOLOGICAL FIELD

Examples of the disclosure relate to user plane interruption time monitoring. Some relate to user plane interruption time monitoring associated with dual connectivity split bearers.

### BACKGROUND

Cellular radio telecommunications networks require that a user equipment can be handed over from one cell to another. During cell change, data transmission via some data radio bearers may not be possible or may be reduced. This has an impact of the quality of service experienced by the user equipment. Knowledge, obtained by the network, of the service experienced by the user equipment can be used for mobility optimisation including, for example, decisions as to which bearers the user equipment should be configured with.

### BRIEF SUMMARY

According to various, but not necessarily all, examples there is provided a method comprising: creating, for transmission, a radio resource control reconfiguration (RRCReconfiguration) message for a user equipment (UE). The RRCReconfiguration message comprises a configuration for monitoring, at the UE, user plane interruption time relating to a primary secondary cell (PSCell) change during a dual connectivity session. The configuration comprises at least one indication of one or more parameters to be used, at the UE, for monitoring user plane interruption time associated with a dual connectivity split bearer.

In some examples, the configuration comprises: an indication to monitor a dual connectivity split bearer part communicated via a master cell group (MCG), at the UE, for user plane interruption time on the dual connectivity split bearer part communicated via the MCG;

In some examples, the configuration comprises: an indication to monitor a dual connectivity split bearer part communicated via a secondary cell group (SCG), at the UE, for user plane interruption time on the dual connectivity split bearer part communicated via the SCG.

In some examples, configuration comprises: an indication to monitor the dual connectivity split bearer part communicated via the MCG and the dual connectivity split bearer part communicated via the SCG, at the UE, for contemporaneous user plane interruption time on the dual connectivity split bearer part communicated via the MCG and the dual connectivity split bearer part communicated via the SCG.

In some examples, a splitting of user data between the dual connectivity split bearer parts occurs at a packet data convergence protocol (PDCP) layer.

In some examples, the configuration comprises: an indication to monitor, at the UE, user plane interruption time on the dual connectivity split bearer in relation to user plane quality of service (QOS) on the dual connectivity split bearer or dual connectivity split bearer parts. In some such examples, the indication comprises one or more user plane QoS thresholds associated with user plane interruption time. In some such examples, the one or more user plane QoS thresholds relate to least one of the following: throughput or packet data convergence protocol (PDCP) service data unit (SDU) loss rate.

In some examples, the configuration comprises: at least one further indication of one or more threshold durations of user plane interruption associated with creating, at the UE, a successful PSCell change report (SPR).

In some examples, the at least one indication specifies the one or more parameters to be used, at the UE, for monitoring user plane interruption time associated with the dual connectivity split bearer.

In some examples, the at least one indication is comprised within a successful PSCell change report (SPR) configuration information element (IE) comprised within the RRCReconfiguration message.

In some examples, the method further comprises: receiving a successful PSCell change report (SPR), originating from the UE, wherein the SPR indicates one or more user plane interruption times associated with the dual connectivity split bearer. In some such examples, the one or more user plane interruption times associated with the dual connectivity split bearer are user plane interruption times measured, at the UE, according to the indicated one or more parameters.

In some examples, the RRCReconfiguration message comprises PSCell change configuration details.

In some examples, changing the PSCell used for dual connectivity to the target PSCell triggers the monitoring, at the UE, of user plane interruption time associated with the dual connectivity split bearer.

According to various, but not necessarily all, examples there is provided a network node comprising: means for creating, for transmission, a radio resource control reconfiguration (RRCReconfiguration) message for a user equipment (UE). The RRCReconfiguration message comprises a configuration for monitoring, at the UE, user plane interruption time relating to a primary secondary cell (PSCell) change during a dual connectivity session. The configuration comprises at least one indication of one or more parameters to be used, at the UE, for monitoring user plane interruption time associated with a dual connectivity split bearer.

In some examples, the network node further comprises means for performing the method described in the preceding paragraphs.

In some examples, the means comprises: at least one processor; and at least one memory including computer program code, the at least one memory storing instructions that, when executed by the at least one processor, cause the network node at least to perform creating, for transmission, the RRCReconfiguration message for a user equipment (UE). In some examples, the instructions, when executed by the at least one processor, cause the network node at least to perform the method described in the preceding paragraphs.

According to various, but not necessarily all, examples there is provided a computer program comprising instructions which, when executed by an apparatus, cause the apparatus to perform at least: creating, for transmission, a radio resource control reconfiguration (RRCReconfiguration) message for a user equipment (UE). The RRCReconfiguration message comprises a configuration for monitoring, at the UE, user plane interruption time relating to a primary secondary cell (PSCell) change during a dual connectivity session. The configuration comprises at least one indication of one or more parameters to be used, at the UE, for monitoring user plane interruption time associated with a dual connectivity split bearer.

In some examples, the computer program further comprising instructions which, when executed by the apparatus, cause the apparatus to the method described in the preceding paragraphs.

According to various, but not necessarily all, examples there is provided a method comprising: receiving a radio resource control reconfiguration (RRCReconfiguration) message from a network. The RRCReconfiguration message comprises a configuration for monitoring, at a user equipment (UE), user plane interruption time relating to a primary secondary cell (PSCell) change during a dual connectivity session. The configuration comprises at least one indication of one or more parameters to be used, at the UE, for monitoring user plane interruption time associated with a dual connectivity split bearer. The method further comprises: measuring one or more user plane interruption times associated with the dual connectivity split bearer according to the indicated one or more parameters.

In some examples, the method further comprises: transmitting a successful PSCell change report (SPR) to the network, wherein the SPR indicates the measured one or more user plane interruption times associated with the dual connectivity split bearer.

In some examples, at least one parameter relates to monitoring a dual connectivity split bearer part. In some such examples, measuring user plane interruption time associated with the dual connectivity split bearer according to this at least one parameter comprises measuring time elapsed between: a time of arrival of a last packet data convergence protocol (PDCP) protocol data unit (PDU) received via a dual connectivity split bearer part before the PSCell change; and a time of arrival of a first non-duplicated PDCP PDU received via the dual connectivity split bearer part after initiating the PSCell change.

In some examples, the dual connectivity split bearer part comprises a dual connectivity split bearer part communicated via a master cell group (MCG) or a dual connectivity split bearer part communicated via a secondary cell group (SCG).

In some examples, when the configuration is for monitoring, at the UE, user plane interruption time relating to both primary cell (PCell) change and primary secondary cell (PSCell) change during the dual connectivity session, the method comprises at least one of the following: measuring user plane interruption time on the dual connectivity split bearer part communicated via the MCG and user plane interruption time on the dual connectivity split bearer part communicated via the SCG; and measuring contemporaneous user plane interruption time on the dual connectivity split bearer part communicated via the MCG and the dual connectivity split bearer part communicated via the SCG.

In some examples, at least one parameter relates to monitoring user plane quality of service (QOS) on the dual connectivity split bearer. In some such examples, measuring user plane interruption time associated with the dual connectivity split bearer according to this at least one parameter comprises measuring time elapsed between: a time of arrival of a last packet data convergence protocol (PDCP) protocol data unit (PDU) received via the dual connectivity split bearer before the PSCell change; and a time when user plane QoS on the dual connectivity split bearer reaches one or more thresholds.

In some examples, the one or more thresholds are in respect of at least one of the following: throughput or PDCP SDU loss rate. In some examples, the one or more thresholds are indicated in the received RRCReconfiguration message.

According to various, but not necessarily all, examples there is provided a user equipment (UE) comprising: means for receiving a radio resource control reconfiguration (RRCReconfiguration) message from a network. The RRCReconfiguration message comprises a configuration for monitoring, at the UE, user plane interruption time relating to a primary secondary cell (PSCell) change during a dual connectivity session. The configuration comprises at least one indication of one or more parameters to be used, at the UE, for monitoring user plane interruption time associated with a dual connectivity split bearer. The UE further comprises means for measuring one or more user plane interruption times associated with the dual connectivity split bearer according to the indicated one or more parameters.

In some examples, the UE further comprises means for performing the method described in the preceding paragraphs.

In some examples, the means comprises: at least one processor; and at least one memory including computer program code, the at least one memory storing instructions that, when executed by the at least one processor, cause the network node at least to perform: receiving the RRCReconfiguration message from a network; and measuring one or more user plane interruption times associated with the dual connectivity split bearer according to the indicated one or more parameters. In some examples, the instructions, when executed by the at least one processor, cause the UE at least to perform the method described in the preceding paragraphs.

According to various, but not necessarily all, examples there is provided a computer program comprising instructions which, when executed by an apparatus, cause the apparatus to perform at least: receiving a radio resource control reconfiguration (RRCReconfiguration) message from a network, wherein the RRCReconfiguration message comprises a configuration for monitoring, at the UE, user plane interruption time relating to a primary secondary cell (PSCell) change during a dual connectivity session, wherein the configuration comprises at least one indication of one or more parameters to be used, at the UE, for monitoring user plane interruption time associated with a dual connectivity split bearer; and measuring one or more user plane interruption times associated with the dual connectivity split bearer according to the indicated one or more parameter.

In some examples, the computer program further comprising instructions which, when executed by the apparatus, cause the apparatus to the method described in the preceding paragraphs.

According to various, but not necessarily all, examples there is provided a method comprising: creating, for transmission, a radio resource control reconfiguration (RRCReconfiguration) message for a user equipment (UE). The RRCReconfiguration message comprises a configuration for monitoring, at the UE, user plane interruption time relating to a primary secondary cell (PSCell) change during a dual connectivity session. The configuration comprises an indication of which one or more dual connectivity split bearer parts are to be monitored, at the UE, for user plane interruption time.

According to various, but not necessarily all, examples there is provided a network node comprising means for performing this method.

In some examples, the means comprises: at least one processor; and at least one memory including computer program code, the at least one memory storing instructions that, when executed by the at least one processor, cause the network node at least to perform this method.

According to various, but not necessarily all, examples there is provided a computer program comprising instructions which, when executed by an apparatus, cause the apparatus to perform this method.

According to various, but not necessarily all, examples there is provided a method comprising: receiving a radio resource control reconfiguration (RRCReconfiguration) message from a network. The RRCReconfiguration message comprises a configuration for monitoring, at the UE, user plane interruption time relating to a primary secondary cell (PSCell) change during a dual connectivity session. The configuration comprises an indication of which one or more dual connectivity split bearer parts are to be monitored, at the UE, for user plane interruption time. The method further comprises measuring user plane interruption time on the indicated one or more dual connectivity split bearer parts.

According to various, but not necessarily all, examples there is provided a UE comprising means for performing this method.

In some examples, the means comprises: at least one processor; and at least one memory including computer program code, the at least one memory storing instructions that, when executed by the at least one processor, cause the network node at least to perform this method.

According to various, but not necessarily all, examples there is provided a computer program comprising instructions which, when executed by an apparatus, cause the apparatus to perform this method.

According to various, but not necessarily all, examples there is provided examples as claimed in the appended claims.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

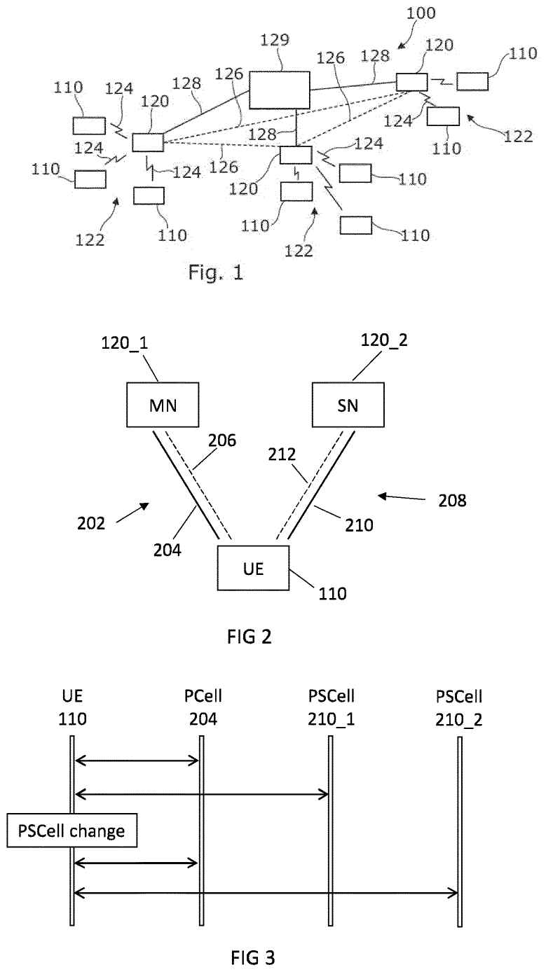

FIG. 1 shows an example of the subject matter described herein;

FIG. 2 shows another example of the subject matter described herein;

FIG. 3 shows another example of the subject matter described herein;

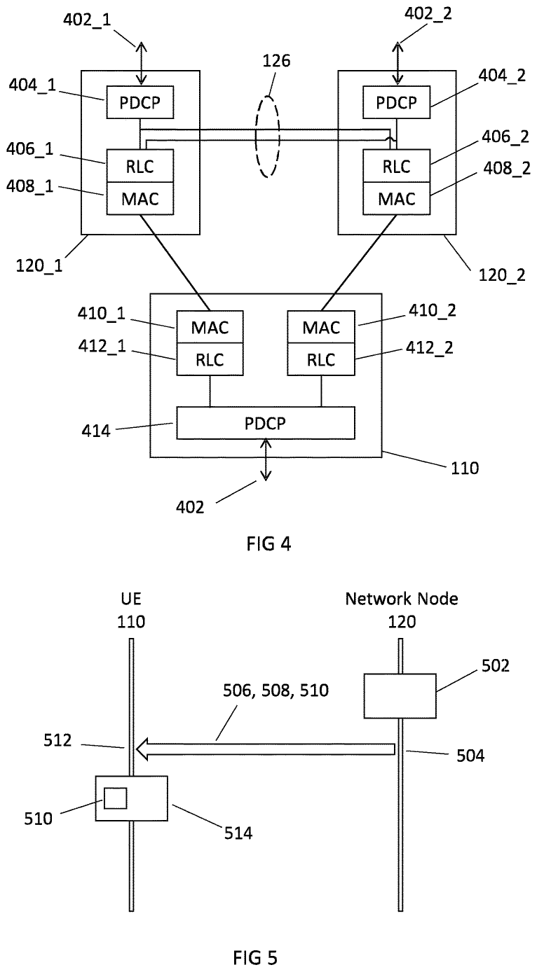

FIG. 4 shows another example of the subject matter described herein;

FIG. 5 shows another example of the subject matter described herein;

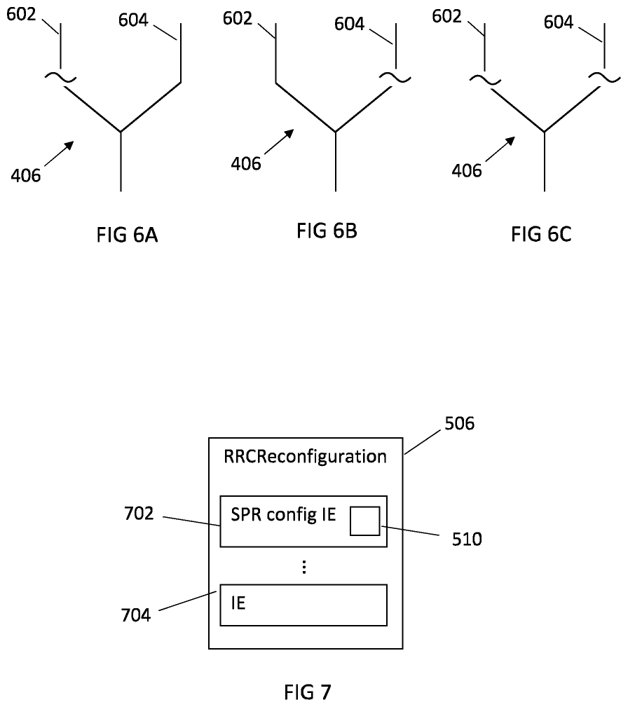

FIGS. 6A to 6C show other examples of the subject matter described herein;

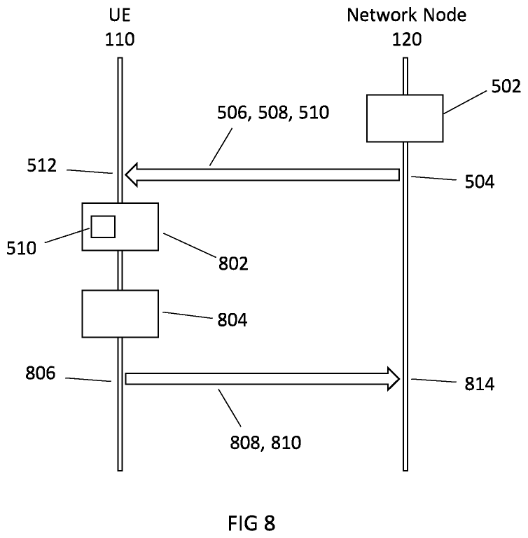

FIG. 7 shows another example of the subject matter described herein;

FIG. 8 shows another example of the subject matter described herein;

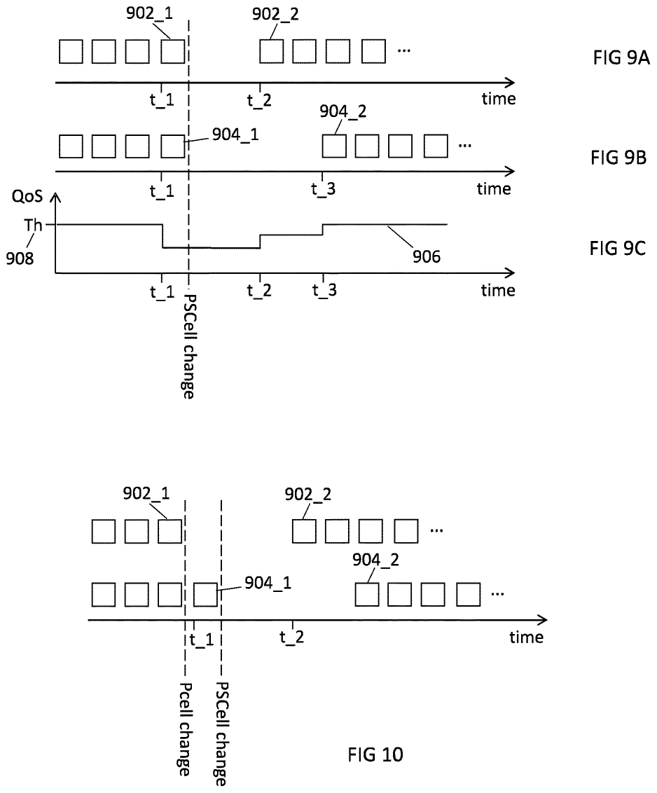

FIGS. 9A to 9C show other examples of the subject matter described herein;

FIG. 10 shows another example of the subject matter described herein;

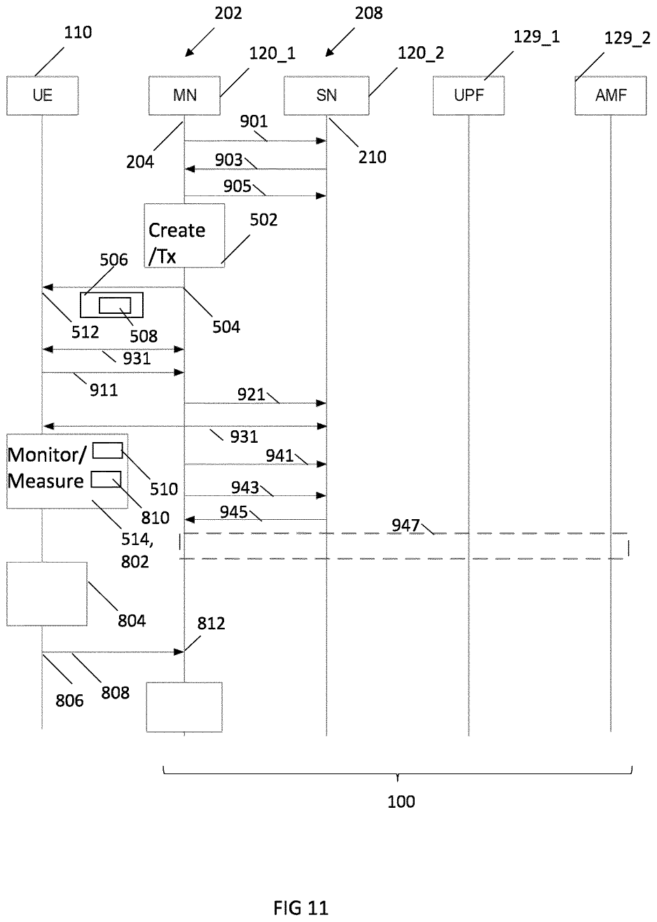

FIG. 11 shows another example of the subject matter described herein;

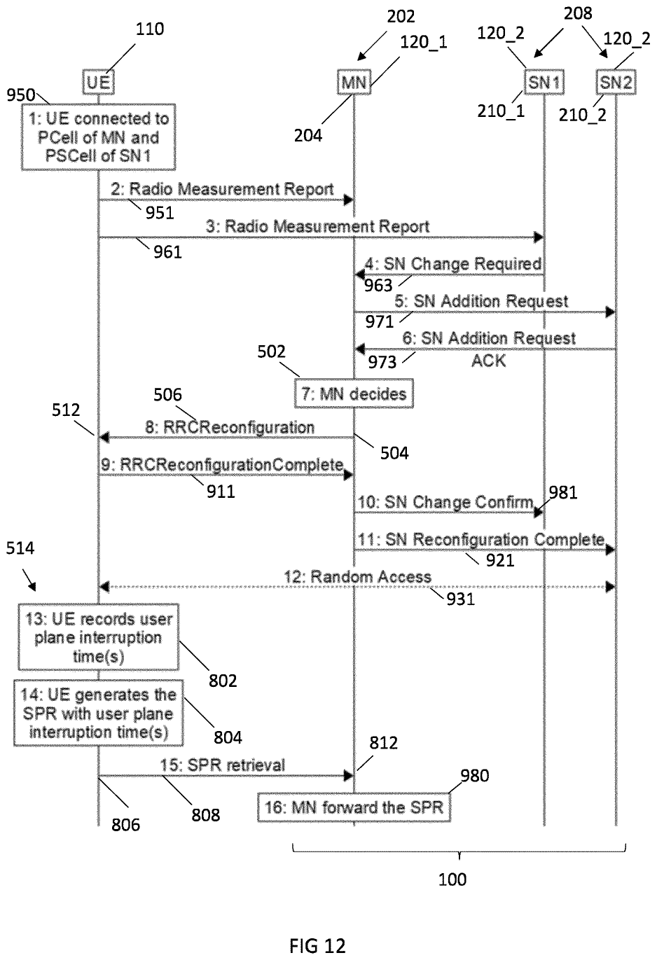

FIG. 12 shows another example of the subject matter described herein;

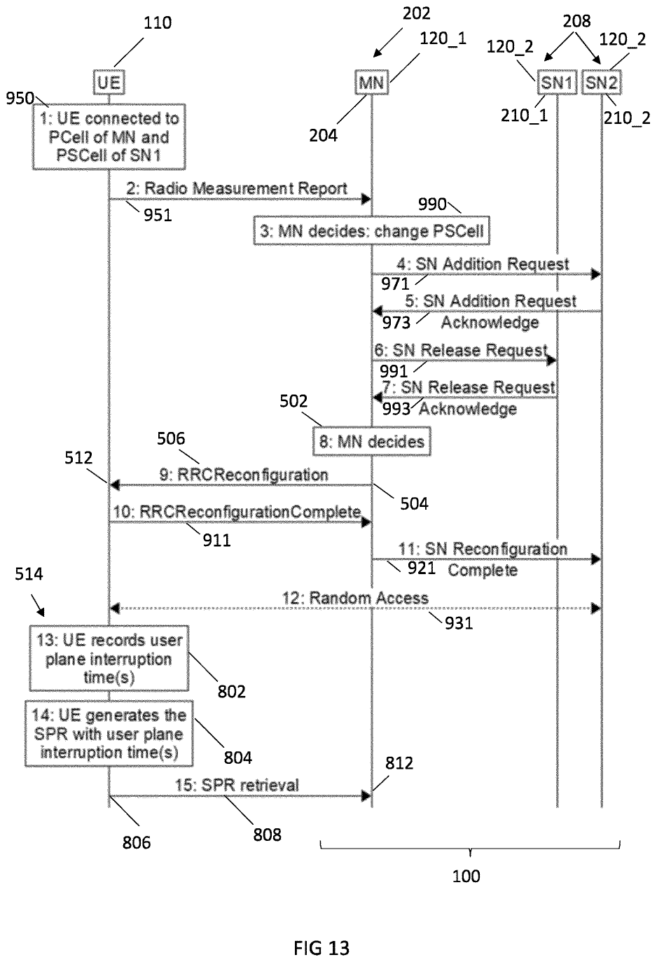

FIG. 13 shows another example of the subject matter described herein;

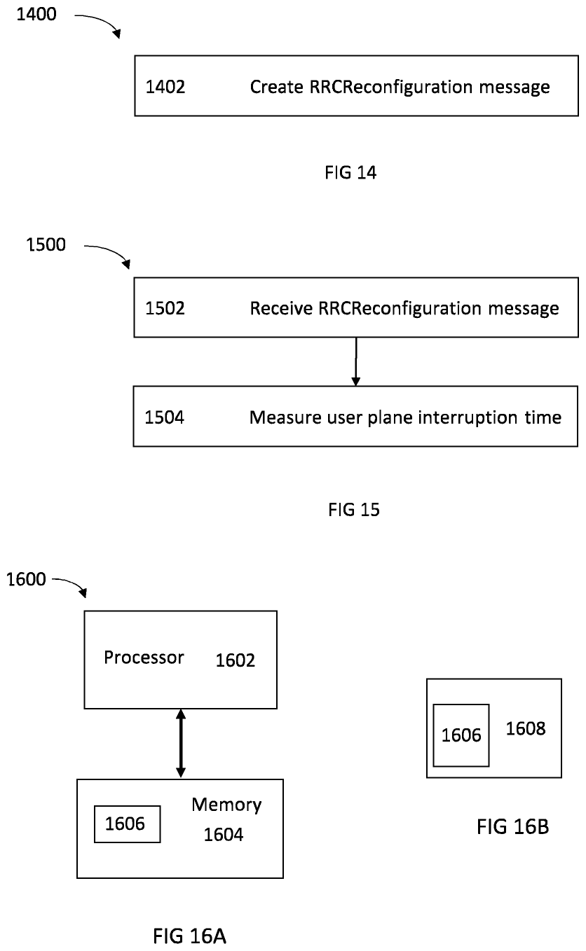

FIG. 14 shows another example of the subject matter described herein;

FIG. 15 shows another example of the subject matter described herein; and

FIGS. 16A and 16B show other examples of the subject matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

### DETAILED DESCRIPTION

The drawings and description relate to examples of a network node 120 comprising: means for creating 502, for transmission 504, a radio resource control reconfiguration (RRCReconfiguration) message 506 for a user equipment (UE) 110. The RRCReconfiguration message 506 comprises a configuration 508 for monitoring 514, at the UE 110, user plane interruption time 810 relating to a primary secondary cell (PSCell) 210 change during a dual connectivity session. The configuration 508 comprises at least one indication of one or more parameters 510 to be used, at the UE 110, for monitoring 514 user plane interruption time 510 associated with a dual connectivity split bearer 402.

The drawings and description relate to examples of a user equipment (UE) 110 comprising: means for receiving 512 a radio resource control reconfiguration (RRCReconfiguration) message 506 from a network 100. The RRCReconfiguration message 506 comprises a configuration 508 for monitoring 514, at the UE 110, user plane interruption time 810 relating to a primary secondary cell (PSCell) 210 change during a dual connectivity session. The configuration 508 comprises at least one indication of one or more parameters 510 to be used, at the UE 110, for monitoring 514 user plane interruption time 510 associated with a dual connectivity split bearer 402. The UE 110 also comprises: means for measuring 802 one or more user plane interruption times 810 associated with the dual connectivity split bearer 402 according to the indicated one or more parameters 510.

FIG. 1 illustrates an example of a network 100 comprising a plurality of network nodes including terminal nodes 110, access nodes 120 and one or more core nodes 129. The terminal nodes 110 and access nodes 120 communicate with each other. The one or more core nodes 129 communicate with the access nodes 120.

The network 100 is in this example a radio telecommunications network, in which at least some of the terminal nodes 110 and access nodes 120 communicate with each other using transmission/reception of radio waves.

The one or more core nodes 129 may, in some examples, communicate with each other. The one or more access nodes 120 may, in some examples, communicate with each other. The network 100 may be a cellular network comprising a plurality of cells 122 each served by an access node 120. In this example, the interface between the terminal nodes 110 and an access node 120 defining a cell 122 is a wireless interface 124.

The access node 120 is a cellular radio transceiver. The terminal nodes 110 are cellular radio transceivers.

In the example illustrated the cellular network 100 is a third generation Partnership Project (3GPP) network in which the terminal nodes 110 are user equipment (UE) and the access nodes 120 are base stations.

In the particular example illustrated the network 100 is an Evolved Universal Terrestrial Radio Access network (E-UTRAN). The E-UTRAN consists of E-UTRAN NodeBs (eNBs) 120, providing the E-UTRA user plane and control plane (RRC) protocol terminations towards the UE 110. The eNBs 120 are interconnected with each other by means of an X2 interface 126. The eNBs are also connected by means of the S1 interface 128 to the Mobility Management Entity (MME) 129.

In other example the network 100 is a Next Generation (or New Radio, NR) Radio Access network (NG-RAN). The NG-RAN consists of gNodeBs (gNBs) 120, providing the user plane and control plane (RRC) protocol terminations towards the UE 110. The gNBs 120 are interconnected with each other by means of an X2/Xn interface 126. The gNBs are also connected by means of the N2 interface 128 to the Access and Mobility management Function (AMF).

In some examples, the network 100 can comprise a combination of E-UTRAN and NG-RAN.

A user equipment comprises a mobile equipment. Where reference is made to user equipment that reference includes and encompasses, wherever possible, a reference to mobile equipment.

FIG. 2 illustrates an example of a dual connectivity session at part of the network 100 comprising a terminal node 110 which is a UE 110 and two network node 120 which are a master node (MN) 120_1 and a secondary node (SN) 120_2.

In DC, the UE 110 has contemporaneous connection to the MN 120_1 and the SN 120_2.

In DC, the configured set of serving cells for a UE 110 has two subsets: a master cell group (MCG) 202 containing the serving cells of the MN 120_1, and a secondary cell group (SCG) 208 containing the serving cells of the SN 120_2.

The MN 120_1 is the network node 120 that provides control plane connectivity towards the core network and the SN 120_2 is the network node 120 that provides additional radio resources for the UE 110 and may also serve for reliability and load balancing. The SN 120_2 may or may not have a connection with the core network.

The MCG 202 comprises a primary cell (PCell) 204 for uplink/downlink connection to the MN 120_1. In some examples, the PCell 204 is the cell of the MCG 202 used to initiate initial access to the MN 120_1 by the UE 110, for example using a random access procedure. The MCG 202 may optionally comprise one or more secondary cells (SCells) 206.

Similarly, the SCG 208 comprises a primary secondary cell (PSCell) 210 for uplink/downlink connection to the SN 120_2. In some examples, the PSCell 210 is the cell of the SCG used to initiate initial access to the SN 120_2 by the UE 110, for example using a random access procedure. The SCG 208 may optionally comprise one or more secondary cells (SCells) 212.

FIG. 3 illustrates an example of a PSCell change during a dual connectivity session.

Before PSCell change, data is transferred between the UE 110 and the MN 120_1 via the PCell 204 and data is transferred between the UE 110 and the SN 120_2 via a first PSCell 210_1.

After PSCell change, data is still transferred between the UE 110 and the MN 120_1 via the PCell 204 but data is transferred between the UE 110 and the SN 120_2 via a second, different PSCell 210_2.

The first and second PSCells 210_1, 210_2 respectively represent source and target PSCells in the PSCell change.

In some examples, the PSCell change may be an intra-SN PSCell change. The first, source PSCell 210_1 and second, target PSCell 210_2 are within the same SCG 208. Before PSCell change, the second, target PSCell 210_2 is a SCell 212 within the SCG 208. Intra-SN PSCell change can be performed using an SN modification procedure for example the SN modification procedure described in 3GPP TS 37.340, clause 10.3, for example the SN modification procedure described in 3GPP TS 37.340, version 17.4.0, clause 10.3. An example of SN modification is illustrated in FIG. 11.

In some examples, the PSCell change may be an inter-SN PSCell change. The first, source PSCell 210_1 and second, target PSCell 210_2 are not within the same SCG 208. The SN 120_2 is therefore changed to a different SN. Inter-SN PSCell change can be performed using an SN change procedure for example the SN change procedure described in 3GPP TS 37.340, clause 10.5, for example the SN change procedure described in 3GPP TS 37.340, version 17.4.0, clause 10.5. Examples of SN change are illustrated in FIGS. 12 and 13.

In some examples, the PSCell change may be initiated by the MN 120_1 or may be initiated by the SN 120_2.

In some examples the PSCell change can be a conditional PSCell change, wherein candidate target PSCell configurations are communicated to the UE 110 along with associated execution conditions and the UE 110 evaluates the execution conditions for the candidate target PSCells in order to determine which to connect with.

FIG. 4 illustrates an example of dual connectivity bearer types.

Dual connectivity bearers are data radio bearers which terminate in either the MN 120_1 or the SN 120_2. They are end to end tunnels terminating at the packet data convergence protocol (PDCP) layer of the user plane protocol stack.

From the UE's perspective, there are three dual connectivity bearer types: MCG bearers, SCG bearers, and split bearers 402.

In contrast to MCG bearers, which exclusively use lower layers of the user plane protocol stack (such as for example, the radio link control (RLC) layer 406_1, medium access control (MAC) layer 408_1 and physical layers) in the MN 120_1, and SCG bearers, which exclusively use lower layers of the user plane protocol stack (such as for example, the RLC layer 406_2, MAC layer 408_2 and physical layers) in the SN 120_2, split bearers 402 use the lower layers 406_1, 408_1, 406_2, 408_2 in both the MN 120_1 and the SN 120_2

MN-terminated split bearers 402_1 have a PDCP 404_1 in the MN 120_1. SN-terminated split bearers 402_2 have a PDCP 404_2 in the SN 120_2. The user data which is to be communicated over the split bearer 402_1, 402_2 is split into two paths: one via the lower layers 406_1, 408_1 of the user plane protocol stack in the MN 120_1 and the other via the lower layers 406_2, 408_2 of the user plane protocol stack in the SN 120_2. This produces a split bearer part communicated via the MCG 202 and a split bearer part communicated via the SCG 208. The splitting of the user data between the split bearer parts occurs at the PDCP layer. Some PDCP PDU from PDCP 404_1 are routed to the lower layers 406_1, 408_1 of the user plane protocol stack in the MN 120_1 whereas other are routed to the lower layers 406_2, 408_2 of the user plane protocol stack in the SN 120_2 via a MN-SN user plane interface such as the X2/Xn interface 126. Likewise, some PDCP PDU from PDCP 404_2 are routed to the lower layers 406_2, 408_2 of the user plane protocol stack in the SN 120_2 whereas other are routed to the lower layers 406_1, 408_1 of the user plane protocol stack in the MN 120_1 via the MN-SN user plane interface 126.

At the UE 110, the split bearer part communicated via the MCG 202 is received by first MAC 410_1 and RLC 412_1 and the split bearer part communicated via the SCG 208 is received by second MAC 410_2 and RLC 412_2. The PDCP PDUs are reassembled at the PDCP layer 414 in the UE 110.

At the UE 110, internal information may be transferred up the user plane protocol stack from lower layers of the user plane protocol stack to the PDCP layer 414 to identify via which dual connectivity split bearer part a PDCP PDU is received.

FIG. 5 illustrates an example of part of the network 100, comprising a terminal node 110 which is a UE 110 and a network node 120 which may be the MN 120_1 or the SN 120_2, during a dual connectivity session.

In the illustrated example, the network node 120 comprises circuitry or other means for creating 502 a RRCReconfiguration message 506. In 3GPP, the RRCReconfiguration message is the command to modify an RRC connection, for example to effect PCell change or PSCell change.

In some examples, the network node 120 can comprise circuitry or other means for transmitting 504 the RRCReconfiguration message 506 for the UE 110.

The RRCReconfiguration message 506 comprises a configuration 508 for monitoring 514, at the UE 110, user plane interruption time relating to a PSCell change during a dual connectivity session. The user plane interruption time may occur as a consequence of the PSCell change.

The configuration 508 comprises at least one indication of one or more parameters 510 to be used, at the UE 110, for monitoring 514 user plane interruption time associated with a dual connectivity split bearer 402.

In some examples, the at least one indication specifies the one or more parameters 510 to be used, at the UE 110, for monitoring user plane interruption time associated with the dual connectivity split bearer 402. The at least one indication is therefore a specification of the one or more parameters 510 to be used, at the UE 110, for monitoring user plane interruption time associated with the dual connectivity split bearer 402. In these examples the UE 110 receives the indication of the one or more parameters 510 as a specification for the user plane interruption time monitoring it is to perform rather than receiving the indication of the one or more parameters 510 as options from which it may select. In these examples the UE 110 is not provided the freedom to choose which one or more parameters 510 to use for user plane interruption time monitoring.

In the illustrated example, the UE 110 comprises circuitry or other means for receiving 512 the RRCReconfiguration message 506 from the network 100.

The UE 110 comprises circuitry or other means for monitoring 214 user plane interruption time associated with the dual connectivity split bearer 402 using the one or more parameters 510 indicated in the RRCReconfiguration message 506.

The monitoring 214 can comprise measuring one or more user plane interruption times associated with the dual connectivity split bearer 402 according to the indicated one or more parameters 510.

The monitoring 214 can be triggered by the changing of the PSCell used for dual connectivity to the target PSCell.

FIG. 6A to 6C illustrate different examples of the extent of user plane interruption on the dual connectivity split bearer 402.

The dual connectivity split bearer part communicated via the MCG 202 is referenced as 602.

The dual connectivity split bearer part communicated via the SCG 208 is referenced as 604.

In the example of FIG. 6A, the dual connectivity split bearer part 602 communicated via the MCG 202 is interrupted. This results in user plane interruption because user data which would have been transmitted over this dual connectivity split bearer part 602 cannot be transmitted while the interruption persists. The user plane interruption may not be experienced at the UE 110 because user data is still received over the uninterrupted dual connectivity split bearer part 604, however user plane quality of service (QOS) experienced at the UE 110 may be degraded.

In some examples, the UE 110 is configured to monitor the dual connectivity split bearer part 602 communicated via the MCG 202 for user plane interruption time by applying the configuration 508 comprised in the RRCReconfiguration message 506. For this purpose, the configuration 508 comprises an indication to monitor the dual connectivity split bearer part 602 communicated via the MCG 202, at the UE 110, for user plane interruption time on the dual connectivity split bearer part 602 communicated via the MCG 202. This is an example of an indication of a parameter 510 to be used, at the UE 110, for monitoring 514 user plane interruption time associated with the dual connectivity split bearer 402.

In the example of FIG. 6B, the dual connectivity split bearer part 604 communicated via the SCG 208 is interrupted. This results in user plane interruption because user data which would have been transmitted over this dual connectivity split bearer part 604 cannot be transmitted while the interruption persists. The user plane interruption may not be experienced at the UE 110 because user data is still received over the uninterrupted dual connectivity split bearer part 602, however user plane quality of service (QOS) experienced at the UE 110 may be degraded.

In some examples, the UE 110 is configured to monitor the dual connectivity split bearer part 604 communicated via the SCG 208 for user plane interruption time by applying the configuration 508 comprised in the RRCReconfiguration message 506. For this purpose, the configuration 508 comprises an indication to monitor the dual connectivity split bearer part 604 communicated via the SCG 208, at the UE 110, for user plane interruption time on the dual connectivity split bearer part 604 communicated via the SCG 208. This is another example of an indication of a parameter 510 to be used, at the UE 110, for monitoring 514 user plane interruption time associated with the dual connectivity split bearer 402.

In the example of FIG. 6C, both the dual connectivity split bearer part 602 communicated via the MCG 202 and the dual connectivity split bearer part 604 communicated via the SCG 208 are interrupted. This results in user plane interruption because user data which would have been transmitted over these dual connectivity split bearer parts 602, 604 cannot be transmitted while the interruption persists.

In some examples, the UE 110 is configured to monitor the dual connectivity split bearer part 602 communicated via the MCG 202 for user plane interruption time and to monitor the dual connectivity split bearer part 604 communicated via the SCG 208 for user plane interruption time by applying the configuration 508 comprised in the RRCReconfiguration message 506. For this purpose, the configuration 508 can comprise indications of both parameters 510 described above.

In the foregoing examples, the configuration 508 comprises an indication of which one or more dual connectivity split bearer parts 602, 604 are to be monitored, at the UE 110, for user plane interruption time. By monitoring user plane interruption time on the dual connectivity split bearer parts 602, 604 rather than on a per-bearer basis, more granular user plane interruption time information can be obtained. This can help to identify the potential impact on the QoS as experienced by the UE 110 during PSCell change. In particular by monitoring the user plane interruption time on a per-split bearer part 602, 604 basis, the interruption in providing service to the UE 110 can be observed from the MN 120_1 and SN 120_2 perspective. This can be used by the network 100 or the operator to determine which bearers to use during future PSCell changes and whether bearer remapping from SN 120_2 to MN 120_1 should be performed to reduce the amount of time QoS may degrade during future PSCell changes.

In some examples, the one or more parameters 510 do not only represent the extent of monitoring for the UE 110 to performed. The one or more parameters 510 can additionally or alternatively represent the degree of interruption to be monitored.

For example, the configuration 508 can comprise an indication to monitor the dual connectivity split bearer part 602 communicated via the MCG 202 and the dual connectivity split bearer part 604 communicated via the SCG 604, at the UE 110, for contemporaneous user plane interruption time on the dual connectivity split bearer part 602 communicated via the MCG 202 and the dual connectivity split bearer part 604 communicated via the SCG 604. This is another example of an indication of a parameter 510 to be used, at the UE 110, for monitoring 514 user plane interruption time associated with the dual connectivity split bearer 402.

In some examples, the configuration 508 comprises an indication to monitor, at the UE 110, user plane interruption time on the dual connectivity split bearer 402 in relation to user plane quality of service (QOS) on the dual connectivity split bearer 402. The indication can comprise one or more user plane QoS thresholds associated with user plane interruption time. The one or more user plane QoS thresholds can relate to least one of the following: throughput or PDCP service data unit (SDU) loss rate. This is another example of an indication of a parameter 510 to be used, at the UE 110, for monitoring 514 user plane interruption time associated with the dual connectivity split bearer 402. By monitoring user plane interruption time on the dual connectivity split bearer 402 in relation to user plane quality of service (QOS) on the dual connectivity split bearer 402, the impact on the user plane QoS as experienced by the UE 110 during PSCell change is directly observed.

In some examples, the configuration 508 comprises:
a first binary indicator indicating whether or not to monitor the dual connectivity split bearer part 602 communicated via the MCG 202, at the UE 110, for user plane interruption time on that dual connectivity split bearer part 602;
a second binary indicator that indicates whether or not to monitor the dual connectivity split bearer part 604 communicated via the SCG 208, at the UE 110, for user plane interruption time on that dual connectivity split bearer part 604;
a third binary indicator that indicates whether or not to monitor the dual connectivity split bearer part 602 communicated via the MCG 202 and the dual connectivity split bearer part 604 communicated via the SCG 208, at the UE 110, for contemporaneous user plane interruption time on those dual connectivity split bearer parts 602, 604; and
a fourth indicator of a user plane QoS threshold which, when non-zero, indicates monitoring, at the UE 110, for user plane interruption time on some or all parts or the whole of the dual connectivity split bearer 402 in relation to the user plane QoS threshold.

These represent a plurality of options for monitoring, at the UE 110, user plane interruption time associated with the dual connectivity split bearer 402. Accordingly, in these examples, the configuration 508 comprises an indication of which one or more of a plurality of options for monitoring user plane interruption time associated with the dual connectivity split bearer 402 are to be used, at the UE 110, for monitoring user plane interruption time associated with the dual connectivity split bearer 402.

FIG. 7 illustrates an example of the RRCReconfiguration message 506. In this example, the at least one indication of the one or more parameters 510 is comprised within a successful PSCell change report (SPR) configuration information element (IE) 702 comprised within the RRCReconfiguration message 506.

In some examples, the SPR configuration IE 702 can additionally comprise at least one further indication of one or more threshold durations of user plane interruption associated with creating, at the UE 110, a successful PSCell change report (SPR). In some examples, the one or more threshold durations comprises a first threshold which represents a trigger for creating the SPR once it is reached. That is, if user plane interruption is persisting beyond this threshold, this will be reported to the network 100. It is not necessary, in this example, to wait until the user plane interruption is over before creating and transmitting the SPR to the network 100. Also in some examples, the one or more threshold durations comprises a second threshold which represents sufficiently short user plane interruption times that it is not necessary to report to the network 100. This can save energy for the UE 110. The first and second thresholds may be either the same or different.

The one or more user plane QoS thresholds which may be indicated in the SPR configuration IE 702 comprised in the RRCReconfiguration message 506 may also include a threshold which represents when the dual connectivity split bearer 402 is fully functional and reaching this threshold may be a trigger for creating the SPR.

The RRCReconfiguration message 506 can comprise other information elements 704. For example, another information element 704 can comprise PSCell change configuration details. The PSCell change configuration details provide details of how the UE 110 shall connect to the new PSCell 210_2.

FIG. 8 illustrates an example in which the UE 110 comprises circuitry or other means for measuring 802 one or more user plane interruption times 810 associated with the dual connectivity split bearer 402 according to the one or more parameters 510 indicated in the RRCReconfiguration message 506.

The UE 110 comprises circuitry or other means for creating 804, for transmission to the network 100, a successful PSCell change report (SPR) 808. The SPR 808 indicates the measured one or more user plane interruption times 810 associated with the dual connectivity split bearer 402.

The content of the SPR 808 can further include one or more from the following:
the cell IDs of the source PSCell 210_1 and the target PSCell 210_2;
location information of the UE 110;
latest radio link measurements of all measurement IDs available at the time PSCell change is executed, including latest radio measurement results of candidate target PSCells in examples where the PSCell change is a conditional PSCell change (CPC);
the time elapsed between CPC execution and reception of the latest configuration for the selected target PSCell 210_2;
a cause that was the trigger for creating the SPR 808;
the cell radio network temporary identifier (C-RNTI) of the target PSCell 210_2;
information on random access attempts (RA-InformationCommon) if the timer (T304) for successful completion of random access on the target PSCell 210_2 is above a threshold.

The UE 110 comprises circuitry or other means for transmitting 806 the SPR 808 to the network 100.

The network node 120 comprises circuitry or other means for receiving 812 the SPR 808, originating from the UE 110.

FIGS. 9A to 9C illustrate examples of measuring the user plane interruption time relating to PSCell change. These are examples of measuring the user plane interruption time associated with the dual connectivity split bearer 402 according to one or more parameters 510 which may be indicated in the RRCReconfiguration message 506.

FIG. 9A illustrates an example of measuring user plane interruption time on the dual connectivity split bearer part 602 communicated via the MCG 202. The user plane interruption time is measured as the time elapsed between a time of arrival (t_1) of a last PDCP PDU 902_1 received via the dual connectivity split bearer part 602 before the PSCell change and a time of arrival (t_2) of a first non-duplicated PDCP PDU 902_2 received via the dual connectivity split bearer part 602 after the PSCell change has been initiated.

FIG. 9B illustrates an example of measuring user plane interruption time on the dual connectivity split bearer part 604 communicated via the SCG 208. The user plane interruption time is measured as the time elapsed between a time of arrival (t_1) of a last PDCP PDU 904_1 received via the dual connectivity split bearer part 604 before the PSCell change and a time of arrival (t_3) of a first non-duplicated PDCP PDU 904_2 received via the dual connectivity split bearer part 604 after the PSCell change has been initiated.

FIG. 9C illustrates an example measuring user plane interruption time on the split bearer 402 with reference to user plane quality of service (QOS) 906, such as throughput or PDCP SDU loss rate, on the dual connectivity split bearer 402. The user plane interruption time is measured as the time elapsed between a time of arrival (t_1) of a last PDCP PDU 902_1, 904_1 received via the dual connectivity split bearer 402 (on either part 602, 604) before the PSCell change and a time (t_3) when user plane QoS 906 on the dual connectivity split bearer 402 reaches one or more thresholds 908. Alternatively, the user plane interruption time could be measured as the time elapsed between a time user plane QoS 906 on the dual connectivity split bearer 402 drops below one or more thresholds 908 and the time (t_3) when user plane QoS 906 on the dual connectivity split bearer 402 reaches the one or more thresholds 908 again. In this latter example, the user plane interruption time represents the length of time during which the UE 110 has received QoS 906 that is lower than the one or more thresholds 908.

FIG. 10 illustrates an example of measuring the user plane interruption time relating to both PCell change and PSCell change. In the illustrated example user plane interruption time is measured on both the dual connectivity split bearer part 602 communicated via the MCG 202 and on the dual connectivity split bearer part 604 communicated via the SCG 208. The user plane interruption time could be measured separately on both in the manner of FIGS. 9A and 9B but in this example the contemporaneous user plane interruption time on both parts 602, 604 is measured. The contemporaneous user plane interruption time on both parts 602, 604 is measured as the time elapsed between a time of arrival (t_1) of a last PDCP PDU received via either part 602, 604 of the dual connectivity split bearer 402 before either of the PCell change and the PSCell change and a time of arrival (t_2) of a first non-duplicated PDCP PDU received via either part 602, 604 of the dual connectivity split bearer 402 after both the PCell change and the PSCell change have been initiated. In the illustrated example, the last PDCP PDU is PDCP PDU 904_1 received via the dual connectivity split bearer part 604 communicated via the SCG 208 and the first non-duplicated PDCP PDU is PDCP PDU 902_2 received via the dual connectivity split bearer part 602 communicated via the MCG 202.

FIGS. 11, 12, 13 illustrate different examples of the apparatus and methods described previously, in the context of particular example implementations.

In these examples, a network 100 (for example a network node 120_1) comprises: means for creating 502, for transmission 504, a radio resource control reconfiguration (RRCReconfiguration) message 506 for a user equipment (UE) 110. The RRCReconfiguration message 506 comprises a configuration 508 for monitoring 514, at the UE 110, user plane interruption time 810 relating to a primary secondary cell (PSCell) 210 change during a dual connectivity session. The configuration 508 comprises at least one indication of one or more parameters 510 to be used, at the UE 110, for monitoring 514 user plane interruption time 510 associated with a dual connectivity split bearer 402 [not illustrated].

In these examples, a user equipment (UE) 110 comprises: means for receiving 512 the radio resource control reconfiguration (RRCReconfiguration) message 506 from the network 100. The received RRCReconfiguration message 506 comprises the configuration 508 for monitoring 514, at the UE 110, user plane interruption time 810 relating to a primary secondary cell (PSCell) 210 change during a dual connectivity session. The configuration 508 comprises at least one indication of one or more parameters 510 to be used, at the UE 110, for monitoring 514 user plane interruption time 510 associated with a dual connectivity split bearer 402. The UE 110 also comprises: means for measuring 802 one or more user plane interruption times 810 associated with the dual connectivity split bearer 402 according to the indicated one or more parameters 510.

The UE 110 comprises circuitry or other means for measuring 802 one or more user plane interruption times 810 associated with the dual connectivity split bearer 402 according to the one or more parameters 510 indicated in the RRCReconfiguration message 506.

The UE 110 comprises circuitry or other means for creating 804, for transmission to the network 100, a successful PSCell change report (SPR) 808. The SPR 808 indicates the measured one or more user plane interruption times 810 associated with the dual connectivity split bearer 402.

The UE 110 comprises circuitry or other means for transmitting 806 the SPR 808 to the network 100.

The network node 120 comprises circuitry or other means for receiving 812 the SPR 808, originating from the UE 110.

In these examples, a master cell group (MCG) 202 comprises a master node (MN) 120_1 and a primary cell (PCell) 204 for uplink/downlink radio connection to the UE110. The MCG 202 may optionally comprise none, one or more secondary cells (SCells) [not illustrated] for uplink/downlink radio connection to the UE 110.

A secondary cell group (SCG) 208 comprises a secondary node (SN) 120_2 and a primary secondary cell (PSCell) 210 for uplink/downlink radio connection to the UE 110. The SCG 208 may optionally comprise none, one or more secondary cells (SCells) [not illustrated] for uplink/downlink radio connection to the UE 110.

FIG. 11 illustrates an example of a PSCell change executed via SN modification initiated by the MN 120_1. This is an intra-SN PSCell change.

FIGS. 12 and 13 illustrate examples of a PSCell 210 change executed via SN change. This is an inter-SN PSCell change. The inter-SN PSCell change is initiated by the SN 120_2 in FIG. 12. The inter-SN PSCell change is initiated by the MN 120_1 in FIG. 13.

FIGS. 11, 12, 13 are similar in that the signalling after the transmission/reception of the reconfiguration (RRCReconfiguration) message 506 comprises at least:
a Random Access Procedure 931 as a consequence of the reconfiguration (RRCReconfiguration) message 506;
a RRC reconfiguration complete message 911 is sent from the UE 110 back to the network 100 to the MN 120_1; and
a SN Reconfiguration complete 921 is sent form the MN 120_1 to an SN.

FIG. 11 illustrates a User Plane Function (UPF) 129_1 and an Access and Mobility management Function (AMF) 129_2. These, and messages sent to and from these during SN change, are omitted from FIGS. 12 and 13 for brevity. Such details may be obtained from 3GPP TS 37.340, clause 10.5, for example the SN change procedure described in 3GPP TS 37.340, version 17.4.0, clause 10.5, for example FIG. 10.5.2-2 and FIG. 10.5.2-1 within said clauses. The User Plane Function (UPF) 129_1 is a part of the network 100 that interconnects the mobile infrastructure and the Data Network. It is the Protocol Data Unit (PDU) session anchor point for providing mobility within and between Radio Access Technologies (RATs). The Access and Mobility management Function (AMF) 129_2 receives all connection and session related information from the User Equipment (UE) and responsible only for handling connection and mobility management tasks. The AMK provides an access point to the 5G core, thereby terminating RAN control plane and UE traffic. The AMG is responsible for mobility management.

FIGS. 11, 12, 13 differ in the MN-SN signalling before the MN 120_1 creates 502, for transmission 504 (e.g. by the PCell 204), a radio resource control reconfiguration (RRCReconfiguration) message 506 for a user equipment (UE) 110.

In FIG. 11, the MN 120_1 exchanges signals with a single SN 120_2. In FIG. 12, the MN 120_1 receives a signal from the original source SN (SN1) 120_2 and exchanges signals with the new target SN (SN2) 120_2. In FIG. 13, the MN 120_1 exchanges signals with the original source SN (SN1) 120_2 and exchanges signals with the new target SN (SN2) 120_2.

Referring to FIG. 11, the MN 120_1 sends to the SN 120_2 a SN Modification Request message 901. The SN 120_2 sends, in reply, a SN Modification Request Acknowledge message 903. The MN 120_1 sends to the SN 120_2 Xn-U Address Information 905.

A network node (e.g. MN 120_1) creates 502, for transmission 504, a radio resource control reconfiguration (RRCReconfiguration) message 506 for a user equipment (UE) 110. The RRCReconfiguration message 506 comprises a configuration 508 for monitoring 514, at the UE 110, user plane interruption time 810 relating to a primary secondary cell (PSCell) 210 change during a dual connectivity session. The configuration 508 comprises at least one indication of one or more parameters 510 to be used, at the UE 110, for monitoring 514 user plane interruption time 510 associated with a dual connectivity split bearer 402 [not illustrated].

The network node can determine, and indicate in the message 506, the parts of the split bearer for user plane interruption time monitoring. Optionally, the network node can determine, and indicate in the message 506, conditions (e.g. thresholds) for triggering user plane interruption time measurement and/or SPR generation.

The network node (e.g. MN 120_1) causes transmission 504 of the radio resource control reconfiguration (RRCReconfiguration) message 506 to the user equipment (UE) 110.

The user equipment (UE) 110 receives 512 the radio resource control reconfiguration (RRCReconfiguration) message 506.

The user equipment (UE) 110 sends as an acknowledgement a RRCReconfigurationComplete message 911 back to the network and the MN 120_1.

The MN 120_1 sends a SN Reconfiguration Complete message 921 to the SN 120_2.

A random access procedure 931 is performed between the UE 110 and the new PSCell 210.

The UE 110 monitors 802 conditions for triggering user plane interruption time measurement and/or SPR generation and when these conditions (e.g. QoS threshold) are met measures 802 and records one or more user plane interruption times 810 associated with the dual connectivity split bearer 402 according to the indicated one or more parameters 510 in the received reconfiguration (RRCReconfiguration) message 506.

The UE 110 creates 804, for transmission to the network 100, a successful PSCell change report (SPR) 808. The SPR 808 indicates the measured one or more user plane interruption times 810 associated with the dual connectivity split bearer 402. For example, UE 110 can generate the SPR with user interruption time(s) for the configured parts of split bearer.

The UE 110 transmits 806 the SPR 808 to the network 100.

The network 100 receives 812 the transmitted SPR 808.

The MN 120_1 sends to the SN 120_2 a SN Status Transfer message 941.

The MN 120_1 performs data forwarding 943 for data received from the UPF 129_1 to the SN 120_2.

The SN 120_2 sends a secondary RAT Data Usage Report 945 to the MN 120_1.

A PDU Session Path Update Procedure 947 follows.

These messages 941, 943, 945, 947 complete the SN modification procedure initiated by the MN 120_1.

Referring to FIG. 12, the UE 110 is initially connected 950 to a PCell 204 of MN 120_1 and a source PSCell 210_1 of a source SN (SN1) 120_2. The UE 110 sends a Radio Measurement Report 951 to the MN 120_1.

Additionally, the UE 110 sends a Radio Measurement Report 961 to the source SN (SN1) 120_2.

The measurement reports can comprise measurement results of the candidate target cells for conditional PSCell change (CPC).

The source SN (SN1) 120_2 sends a SN change required message 963 to the MN 120_1.

The source SN (SN1) 120_2 thus initiates inter-SN PSCell change.

The MN 120_1 sends a SN Addition Request message 971 to a target SN (SN2) 120_2.

The target SN (SN2) 120_2 sends, in reply, a SN Addition Request ACK message 973 to the MN 120_1.

A network node (e.g. MN 120_1) creates 502, for transmission 504, a radio resource control reconfiguration (RRCReconfiguration) message 506 for a user equipment (UE) 110. The RRCReconfiguration message 506 comprises a configuration 508 for monitoring 514, at the UE 110, user plane interruption time 810 relating to a primary secondary cell (PSCell) 210 change during a dual connectivity session. The configuration 508 comprises at least one indication of one or more parameters 510 to be used, at the UE 110, for monitoring 514 user plane interruption time 510 associated with a dual connectivity split bearer 402 [not illustrated].

The network node can determine, and indicate in the message 506, the parts of the split bearer for user plane interruption time monitoring. Optionally, the network node can determine, and indicate in the message 506, conditions (e.g. thresholds) for triggering user plane interruption time measurement and/or SPR generation.

The network node (e.g. MN 120_1) causes transmission 504 of the radio resource control reconfiguration (RRCReconfiguration) message 506 to the user equipment (UE) 110.

The user equipment (UE) 110 receives 512 the radio resource control reconfiguration (RRCReconfiguration) message 506.

The user equipment (UE) 110 sends as an acknowledgement a RRCReconfigurationComplete message 911 back to the network and the MN 120_1.

The MN 120_1 sends a SN change confirm message 981 to the source SN (SN1) 120_2.

The MN 120_1 sends a SN Reconfiguration Complete message 921 to the target SN (SN2) 120 2.

A random access procedure 931 is performed between the UE 110 and the new PSCell 210_2.

The UE 110 monitors 802 conditions for triggering user plane interruption time measurement and/or SPR generation and when these conditions (e.g. QoS threshold) are met measures 802 and records one or more user plane interruption times 810 associated with the dual connectivity split bearer 402 according to the indicated one or more parameters 510 in the received reconfiguration (RRCReconfiguration) message 506.

The UE 110 creates 804, for transmission to the network 100, a successful PSCell change report (SPR) 808. The SPR 808 indicates the measured one or more user plane interruption times 810 associated with the dual connectivity split bearer 402. For example, UE 110 can generate the SPR with user interruption time(s) for the configured parts of split bearer.

The UE 110 transmits 806 the SPR 808 to the network 100.

The network 100 receives 812 the transmitted SPR 808.

Optionally the MN 120_1 can forward 980 the SPR 808 to the source SN (SN1) 120_2 because SN1 triggered the PSCell change

Referring to FIG. 13, the UE 110 is initially connected 950 to a PCell 204 of MN 120_1 and a source PSCell 210_1 of a source SN (SN1) 120_2. The UE 110 sends a Radio Measurement Report 951 to the MN 120_1.

The measurement reports can comprise measurement results of the candidate target cells for conditional PSCell change (CPC).

The MN 120_1 decides 990 to change the PSCell to PSCell of target SN (SN2) 120_2. The MN 120_1 thus initiates inter-SN PSCell change.

The MN 120_1 sends a SN Addition Request message 971 to a target SN (SN2) 120_2.

The target SN (SN2) 120_2 sends, in reply, an SN addition request ACK message 973 to the MN 120_1.

The MN 120_1 sends a SN Release Request message 991 to the source SN (SN1) 120_2.

The source SN (SN1) 120_2 sends, in reply, an SN release request ACK message 993 to the MN 120_1.

A network node (e.g. MN 120_1) creates 502, for transmission 504, a radio resource control reconfiguration (RRCReconfiguration) message 506 for a user equipment (UE) 110. The RRCReconfiguration message 506 comprises a configuration 508 for monitoring 514, at the UE 110, user plane interruption time 810 relating to a primary secondary cell (PSCell) 210 change during a dual connectivity session. The configuration 508 comprises at least one indication of one or more parameters 510 to be used, at the UE 110, for monitoring 514 user plane interruption time 510 associated with a dual connectivity split bearer 402 [not illustrated].

The network node can determine, and indicate in the message 506, the parts of the split bearer for user plane interruption time monitoring. Optionally, the network node can determine, and indicate in the message 506, conditions (e.g. thresholds) for triggering user plane interruption time measurement and/or SPR generation.

The network node (e.g. MN 120_1) causes transmission 504 of the radio resource control reconfiguration (RRCReconfiguration) message 506 to the user equipment (UE) 110.

The user equipment (UE) 110 receives 512 the radio resource control reconfiguration (RRCReconfiguration) message 506.

The user equipment (UE) 110 sends as an acknowledgement a RRCReconfigurationComplete message 911 back to the network and the MN 120_1.

The MN 120_1 sends a SN Reconfiguration Complete message 921 to the target SN (SN2) 120 2.

A random access procedure 931 is performed between the UE 110 and the new PSCell 210_2 of the target SN (SN2) 120_2.

The UE 110 monitors 802 conditions for triggering user plane interruption time measurement and/or SPR generation and when these conditions (e.g. QoS threshold) are met measures 802 and records one or more user plane interruption times 810 associated with the dual connectivity split bearer 402 according to the indicated one or more parameters 510 in the received reconfiguration (RRCReconfiguration) message 506.

The UE 110 creates 804, for transmission to the network 100, a successful PSCell change report (SPR) 808. The SPR 808 indicates the measured one or more user plane interruption times 810 associated with the dual connectivity split bearer 402. For example, UE 110 can generate the SPR with user interruption time(s) for the configured parts of split bearer.

The UE 110 transmits 806 the SPR 808 to the network 100.

The network 100 receives 812 the transmitted SPR 808.

FIG. 14 illustrates an example of a method 1400. The method 1400 can be performed by the network node 120.

At block 1402, the method 1400 comprises creating, for transmission 504, a radio resource control reconfiguration (RRCReconfiguration) message 506 for a user equipment (UE) 110.

The RRCReconfiguration message 506 comprises a configuration 508 for monitoring, at the UE 110, user plane interruption time 810 relating to a primary secondary cell (PSCell) 210 change during a dual connectivity session.

The configuration 508 comprises at least one indication of one or more parameters 510 to be used, at the UE 110, for monitoring user plane interruption time 510 associated with a dual connectivity split bearer 402.

Additional blocks in the method 1400 may comprise transmitting the RRCReconfiguration message 506 for the UE 110 and receiving a successful PSCell change report (SPR) 808, originating from the UE 110. The SPR 808 indicates one or more user plane interruption times 810 associated with the dual connectivity split bearer 402. The one or more user plane interruption times 810 associated with the dual connectivity split bearer 402 are user plane interruption times measured, at the UE 110, according to the indicated one or more parameters 510.

FIG. 15 illustrates an example of a method 1500. The method 1500 can be performed by the UE 110.

At block 1502, the method 1500 comprises receiving a radio resource control reconfiguration (RRCReconfiguration) message 506 from the network 100.

The RRCReconfiguration message 506 comprises a configuration 508 for monitoring, at the UE 110, user plane interruption time 810 relating to a primary secondary cell (PSCell) 210 change during a dual connectivity session.

The configuration 508 comprises at least one indication of one or more parameters 510 to be used, at the UE 110, for monitoring user plane interruption time 510 associated with a dual connectivity split bearer 402.

At block 1504, the method 1500 comprises measuring one or more user plane interruption times 810 associated with the dual connectivity split bearer 402 according to the indicated one or more parameters 510.

Additional block in the method 1500 may comprise creating, for transmission to the network 100, a successful PSCell change report (SPR) 808 and transmitting 806 the SPR 808 to the network 100. The SPR 808 indicates the measured one or more user plane interruption times 810 associated with the dual connectivity split bearer 402.

FIG. 16A illustrates an example of a controller 1600 suitable for use in the UE 110 or the network node 120, for example the MN 120_1 or the SN 120_2. Implementation of a controller 1600 may be as controller circuitry. The controller 1600 may be implemented in hardware alone, have certain aspects in software including firmware alone or can be a combination of hardware and software (including firmware).

As illustrated in FIG. 16A the controller 1600 may be implemented using instructions that enable hardware functionality, for example, by using executable instructions of a computer program 1606 in a general-purpose or special-purpose processor 1602 that may be stored on a computer readable storage medium (disk, memory etc) to be executed by such a processor 1602.

The processor 1602 is configured to read from and write to the memory 1604. The processor 1602 may also comprise an output interface via which data and/or commands are output by the processor 1602 and an input interface via which data and/or commands are input to the processor 1602.

The memory 1604 stores a computer program 1606 comprising computer program instructions (computer program code) that controls the operation of the apparatus [REF5] when loaded into the processor 1602. The computer program instructions, of the computer program 1606, provide the logic and routines that enables the UE 110 or network node 120 to perform the methods illustrated in the accompanying FIGS. The processor 1602 by reading the memory 1604 is able to load and execute the computer program 1606.

The UE 110 comprises:
at least one processor 1602; and
at least one memory 1604 including computer program code
the at least one memory 1604 and the computer program code configured to, with the at least one processor 1602, cause the UE 110 at least to perform:
receiving 512 a radio resource control reconfiguration (RRCReconfiguration) message 506 from a network 100,
wherein the RRCReconfiguration message 506 comprises a configuration 508 for monitoring 514, at the UE 110, user plane interruption time 810 relating to a primary secondary cell (PSCell) 210 change during a dual connectivity session,
wherein the configuration 508 comprises at least one indication of one or more parameters 510 to be used, at the UE 110, for monitoring 514 user plane interruption time 510 associated with a dual connectivity split bearer 402; and
measuring 802 one or more user plane interruption times 810 associated with the dual connectivity split bearer 402 according to the indicated one or more parameters 510.

The network node 120 comprises:
at least one processor 1602; and
at least one memory 1604 including computer program code
the at least one memory 1604 and the computer program code configured to, with the at least one processor 1602, cause the network node 120 at least to perform:
creating 502, for transmission 504, a radio resource control reconfiguration (RRCReconfiguration) message 506 for a user equipment (UE) 110,
wherein the RRCReconfiguration message 506 comprises a configuration 508 for monitoring 514, at the UE 110, user plane interruption time 810 relating to a primary secondary cell (PSCell) 210 change during a dual connectivity session,
wherein the configuration 508 comprises at least one indication of one or more parameters 510 to be used, at the UE 110, for monitoring 514 user plane interruption time 510 associated with a dual connectivity split bearer 402.

The Ue 110 comprises:
at least one processor 1602; and
at least one memory 1604 including computer program code,
the at least one memory storing instructions that, when executed by the at least one processor 1602, cause the UE 110 at least to:
receiving 512 a radio resource control reconfiguration (RRCReconfiguration) message 506 from a network 100,
wherein the RRCReconfiguration message 506 comprises a configuration 508 for monitoring 514, at the UE 110, user plane interruption time 810 relating to a primary secondary cell (PSCell) 210 change during a dual connectivity session,
wherein the configuration 508 comprises at least one indication of one or more parameters 510 to be used, at the UE 110, for monitoring 514 user plane interruption time 510 associated with a dual connectivity split bearer 402; and
measuring 802 one or more user plane interruption times 810 associated with the dual connectivity split bearer 402 according to the indicated one or more parameters 510.

The network node 120 comprises:
at least one processor 1602; and
at least one memory 1604 including computer program code,
the at least one memory storing instructions that, when executed by the at least one processor 1602, cause the network node 120 at least to:
creating 502, for transmission 504, a radio resource control reconfiguration (RRCReconfiguration) message 506 for a user equipment (UE) 110,
wherein the RRCReconfiguration message 506 comprises a configuration 508 for monitoring 514, at the UE 110, user plane interruption time 810 relating to a primary secondary cell (PSCell) 210 change during a dual connectivity session,
wherein the configuration 508 comprises at least one indication of one or more parameters 510 to be used, at the UE 110, for monitoring 514 user plane interruption time 510 associated with a dual connectivity split bearer 402.

As illustrated in FIG. 16B, the computer program 1606 may arrive at the UE 110 or the network node 120 via any suitable delivery mechanism 1608. The delivery mechanism 1608 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 1606. The delivery mechanism may be a signal configured to reliably transfer the computer program 1606. The UE 110 or the network node 120 may propagate or transmit the computer program 1606 as a computer data signal.

Computer program instructions for causing the UE 110 to perform at least the following or for performing at least the following:
receiving 512 a radio resource control reconfiguration (RRCReconfiguration) message 506 from a network 100,
wherein the RRCReconfiguration message 506 comprises a configuration 508 for monitoring 514, at the UE 110, user plane interruption time 810 relating to a primary secondary cell (PSCell) 210 change during a dual connectivity session,
wherein the configuration 508 comprises at least one indication of one or more parameters 510 to be used, at the UE 110, for monitoring 514 user plane interruption time 510 associated with a dual connectivity split bearer 402; and
measuring 802 one or more user plane interruption times 810 associated with the dual connectivity split bearer 402 according to the indicated one or more parameters 510.

Computer program instructions for causing the network node 120 to perform at least the following or for performing at least the following:
creating 502, for transmission 504, a radio resource control reconfiguration (RRCReconfiguration) message 506 for a user equipment (UE) 110,
wherein the RRCReconfiguration message 506 comprises a configuration 508 for monitoring 514, at the UE 110, user plane interruption time 810 relating to a primary secondary cell (PSCell) 210 change during a dual connectivity session,
wherein the configuration 508 comprises at least one indication of one or more parameters 510 to be used, at the UE 110, for monitoring 514 user plane interruption time 510 associated with a dual connectivity split bearer 402.

The computer program instructions may be comprised in a computer program, a non-transitory computer readable medium, a computer program product, a machine readable medium. In some but not necessarily all examples, the computer program instructions may be distributed over more than one computer program.

Although the memory 1604 is illustrated as a single component/circuitry it may be implemented as one or more separate components/circuitry some or all of which may be integrated/removable and/or may provide permanent/semi-permanent/dynamic/cached storage.

Although the processor 1602 is illustrated as a single component/circuitry it may be implemented as one or more separate components/circuitry some or all of which may be integrated/removable. The processor 1602 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single /multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the accompanying FIGS may represent steps in a method and/or sections of code in the computer program 1606. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

The above-described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “ determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. A network node comprising:
at least one processor; and
at least one memory including computer program code;
the at least one memory storing instructions that, when executed by the at least one processor, cause the network node at least to perform:
creating, for transmission, a radio resource control reconfiguration (RRCReconfiguration) message for a user equipment (UE),
wherein the RRCReconfiguration message comprises a configuration for monitoring, at the UE, user plane interruption time relating to a primary secondary cell (PSCell) change during a dual connectivity session,
wherein the configuration comprises at least one indication of one or more parameters to be used, at the UE, for monitoring user plane interruption time associated with a dual connectivity split bearer.

2. The network node of claim 1 wherein the configuration comprises:
an indication to monitor a dual connectivity split bearer part communicated via a master cell group (MCG), at the UE, for user plane interruption time on the dual connectivity split bearer part communicated via the MCG.

3. The network node of claim 1 wherein the configuration comprises:
an indication to monitor a dual connectivity split bearer part communicated via a secondary cell group (SCG), at the UE, for user plane interruption time on the dual connectivity split bearer part communicated via the SCG.

4. The network node of claim 1 wherein configuration comprises:
an indication to monitor the dual connectivity split bearer part communicated via the MCG and the dual connectivity split bearer part communicated via the SCG, at the UE, for contemporaneous user plane interruption time on the dual connectivity split bearer part communicated via the MCG and the dual connectivity split bearer part communicated via the SCG.

5. The network node of claim 1 wherein the configuration comprises:
an indication to monitor, at the UE, user plane interruption time on the dual connectivity split bearer in relation to user plane quality of service (QOS) on the dual connectivity split bearer or dual connectivity split bearer parts.

6. The network node of claim 5 wherein the indication comprises one or more user plane QoS thresholds associated with user plane interruption time.

7. The network node of claim 6 wherein the one or more user plane QoS thresholds relate to least one of the following: throughput or packet data convergence protocol (PDCP) service data unit (SDU) loss rate.

8. The network node of claim 1 wherein the configuration comprises:
at least one further indication of one or more threshold durations of user plane interruption associated with creating, at the UE, a successful PSCell change report (SPR).

9. The network node of claim 1 wherein the at least one indication specifies the one or more parameters to be used, at the UE, for monitoring user plane interruption time associated with the dual connectivity split bearer.

10. The network node of claim 1 wherein the at least one indication is comprised within a successful PSCell change report (SPR) configuration information element (IE) comprised within the RRCReconfiguration message.

11. The method network node of preceding claim 1 further caused to perform: receiving a successful PSCell change report (SPR), originating from the UE, wherein the SPR indicates one or more user plane interruption times associated with the dual connectivity split bearer.

12. The network node of claim 11 wherein the one or more user plane interruption times associated with the dual connectivity split bearer are user plane interruption times measured, at the UE, according to the indicated one or more parameters.

13.-15. (canceled)

16. A user equipment (UE) comprising:
at least one processor; and
at least one memory including computer program code;
the at least one memory and the computer program code configured to, with the at least one processor, cause the UE at least to perform:
receiving a radio resource control reconfiguration (RRCReconfiguration) message from a network,
wherein the RRCReconfiguration message comprises a configuration for monitoring, at the UE, user plane interruption time relating to a primary secondary cell (PSCell) change during a dual connectivity session,
wherein the configuration comprises at least one indication of one or more parameters to be used, at the UE, for monitoring user plane interruption time associated with a dual connectivity split bearer; and
measuring one or more user plane interruption times associated with the dual connectivity split bearer according to the indicated one or more parameters.

17. The UE of claim 16 further caused to perform: transmitting a successful PSCell change report (SPR) to the network, wherein the SPR indicates the measured one or more user plane interruption times associated with the dual connectivity split bearer.

18. The UE of claim 16 wherein at least one parameter relates to monitoring a dual connectivity split bearer part, and wherein measuring user plane interruption time associated with the dual connectivity split bearer according to this at least one parameter comprises measuring time elapsed between:
a time of arrival of a last packet data convergence protocol (PDCP) protocol data unit (PDU) received via a dual connectivity split bearer part before the PSCell change; and
a time of arrival of a first non-duplicated PDCP PDU received via the dual connectivity split bearer part after initiating the PSCell change.

19. The UE of claim 18 wherein the dual connectivity split bearer part comprises a dual connectivity split bearer part communicated via a master cell group (MCG) or a dual connectivity split bearer part communicated via a secondary cell group (SCG).

20. The UE of claim 19 wherein the configuration is for monitoring, user plane interruption time relating to both primary cell (PCell) change and primary secondary cell (PSCell) change during the dual connectivity session, and the UE is caused to perform at least one of the following:
measuring user plane interruption time on the dual connectivity split bearer part communicated via the MCG and user plane interruption time on the dual connectivity split bearer part communicated via the SCG; and
measuring contemporaneous user plane interruption time on the dual connectivity split bearer part communicated via the MCG and the dual connectivity split bearer part communicated via the SCG.

21. The UE of claim 16 wherein at least one parameter relates to monitoring user plane quality of service (QOS) on the dual connectivity split bearer, and wherein measuring user plane interruption time associated with the dual connectivity split bearer according to this at least one parameter comprises measuring time elapsed between:
a time of arrival of a last packet data convergence protocol (PDCP) protocol data unit (PDU) received via the dual connectivity split bearer before the PSCell change; and
a time when user plane QoS on the dual connectivity split bearer reaches one or more thresholds.

22. The UE of claim 21 wherein the one or more thresholds are in respect of at least one of the following: throughput or PDCP SDU loss rate.

23. The UE of claim 21 wherein the one or more thresholds are indicated in the received RRCReconfiguration message.

24.-25. (canceled)
